(19) United States
(12) Patent Application Publication
(10) Pub. No.: US 2006/0168145 A1
(43) Pub. Date: Jul. 27, 2006

(54) Method for creating a secure and reliable content distribution framework

(76) Inventor: William M. Pitts, Los Altos, CA (US)

Correspondence Address: Donald E. Schreiber;A Professional Corporation, Post Office Box 2926, Kings Beach, CA, 96143-2926, US

(21) Appl. No.: 11/353,627

(22) Filed: Feb. 13, 2006

Related U.S. Application Data
(63) Continuation-in-part of application No. 11/008,556, filed on Dec. 9, 2004.
Application No. 11/008,556 is a continuation-in-part of application No. 10/466,968, filed on Jul. 21, 2003, now Pat. No. 6,847,968.
(60) Provisional application No. 60/652,289, filed on Feb. 11, 2005.

(30) Foreign Application Priority Data
Feb. 8, 2002 (WO) PCT/US02/03617

(51) Int. Cl. G06F 15/16

(52) U.S. Cl. 709/219; 709/231

(57) ABSTRACT

An upstream NDC site accesses a file that is alternatively accessible through at least two downstream NDC sites. The downstream NDC sites belong to a DDS domain which is a sub-domain of a domain at the upstream NDC site. Portal files at each downstream NDC store distinct network addresses for communicating with the different downstream NDC. A DDS domain manager at the upstream NDC site retrieves and uses a first network address for establishing data conduit between the upstream NDC site and one of the downstream NDC sites. If the upstream NDC site fails to receive a response to a message, that site uses a second network address for establishing a second data conduit between the upstream NDC site and the other downstream NDC site. In another aspect, the NDC sites ensure consistency between the file and the projected image of the file cached in the upstream NDC site.

### CROSS REFERENCE(S) TO RELATED APPLICATION(S)

This patent application is a continuation-in-part of U.S. patent application Ser. No. 11/008,556 filed Dec. 9, 2004; which is a continuation-in-part of application Ser. No. 10/466,968 filed Jul. 21, 2003, that issued Jan. 25, 2005, as U.S. Pat. No. 6,847,968 B2; which was filed pursuant to 35 U.S.C. § 371 claiming priority from Patent Cooperation Treaty (“PCT”) International Application Number PCT/US02/03617 filed 8 Feb. 2002 (08.02.2002) that was published 22 Aug. 2002, (22.08.2002) International Publication Number WO 02/065342 A1.

This patent application also claims the benefit of U.S. Provisional Patent Application No. 60/652,289 filed on Feb. 11, 2005.

### BACKGROUND

1. Technical Field

The present disclosure relates generally to the technical field of distributed file systems technology, and, more particularly, to facilitating one networked digital computer's access to a file that is stored at another networked digital computer.

2. Background Art

U.S. Pat. Nos. 5,611,049, 5,892,914, 6,026,452, 6,085,234 and 6,205,475 disclose methods and devices used in a networked, multi-processor digital computer system for caching images of files at various computers within the system. All five (5) United States patents are hereby incorporated by reference as though fully set forth here.

FIG. 1 is a block diagram depicting such a networked, multi-processor digital computer system that is referred to by the general reference character 20. The digital computer system 20 includes a Network Distributed Cache (“NDC”) server terminator site 22, an NDC client terminator site 24, and a plurality of intermediate NDC sites 26A and 26B. Each of the NDC sites 22, 24, 26A and 26B in the digital computer system 20 includes a processor and RAM, neither of which are illustrated in FIG. 1. Furthermore, the NDC server terminator site 22 includes a disk drive 32 for storing data that may be accessed by the NDC client terminator site 24. The NDC client terminator site 24 and the intermediate NDC site 26B both include their own respective hard disks 34 and 36. A client workstation 42 communicates with the NDC client terminator site 24 via an Ethernet, 10BaseT or other type of Local Area Network (“LAN”) 44 in accordance with a network protocol such as a Server Message Block (“SMB”), Common Internet File System (“CIFS”), Network File System (“NFS®”), Hyper-Text Transfer Protocol (“HTTP”) , Netware Core Protocol (“NCP”), or other network-file-services protocols.

Each of the NDC sites 22, 24, 26A and 26B in the networked digital computer system 20 includes an NDC 50 depicted in an enlarged illustration adjacent to intermediate NDC site 26A. The NDCs 50 in each of the NDC sites 22, 24, 26A and 26B include a set of computer programs and a data cache located in the RAM of the NDC sites 22, 24, 26A and 26B. The NDCs 50 together with Data Transfer Protocol (“DTP”) messages 52, illustrated in FIG. 1 by the lines joining pairs of NDCs 50, use conventional data communication networks so the client workstation 42 may access data on the disk drive 32 via the chain of NDC sites 24, 26B, 26A and 22.

The data communication network illustrated in FIG. 1 by which the client workstation 42 accesses data on the disk drive 32 depends upon proper operation of both:

1. the NDC sites 22, 24, 26A and 26B; and

2. communication links connecting those sites which carry the DTP messages 52 between pairs of NDCs 50.

Load balancing routers having a failover capability are offered by networking product companies such as Cisco Systems, Inc. of San Jose, Calif. Such load balancing routers 152, illustrated in FIG. 1A in a conventional application, may be deployed in communication links interconnecting any pair of NDC sites 22-26A, 26A-26B and/or 26B-24 for:

1. increasing the number of communication links interconnecting pairs of NDC sites; and

2. improving the reliability of the communication link between pairs of NDC sites.

In the illustration of FIG. 1A, one side of the load balancing router 152 exchanges HTTP protocol messages with the Internet 154 while the other side exchanges HTTP protocol messages with one side of a number of HTTP proxy caches 156. The other side of the HTTP proxy caches 156 exchange messages with an Internet Web Server 158 whenever there is a “cache miss.” The failover capability of the load balancing router 152 accommodates failure of a communication link to one of the HTTP proxy caches 156 or of the HTTP proxy cache 156 by automatically re-directing HTTP protocol messages to a communication link connected to one of the other operational HTTP proxy caches 156.

Returning again to FIG. 1, the NDCs 50 operate on a data structure called a “dataset.” Datasets are named sequences of bytes of data that are addressed by:
a server-id that identifies the NDC server site where source data is located, such as NDC server terminator site 22; and
a dataset-id that identifies a particular item of source data stored at that site, usually on a hard disk, such as the disk drive 32 of the NDC server terminator site 22.
   Topology of an NDC Network

An NDC network, such as that illustrated in FIG. 1 having NDC sites 22, 24, 26A and 26B, includes:

1. all nodes in a network of processors that are configured to participate as NDC sites; and

2. the DTP messages 52 that bind together NDC sites, such as NDC sites 22, 24, 26A and 26B.

Any node in a network of processors that possesses a megabyte or more of surplus RAM may be configured as an NDC site. NDC sites communicate with each other via the DTP messages 52 in a manner that is completely compatible with non-NDC sites.

FIG. 1 depicts a series of NDC sites 22, 24, 26A and 26B linked together by the DTP messages 52 that form a chain connecting the client workstation 42 to the NDC server terminator site 22. The NDC chain may be analogized to an electrical transmission line. The transmission line of the NDC chain is terminated at both ends, i.e., by the NDC server terminator site 22 and by the NDC client terminator site 24. Thus, the NDC server terminator site 22 may be referred to as an NDC server terminator site for the NDC chain, and the NDC client terminator site 24 may be referred to as an NDC client terminator site for the NDC chain. An NDC server terminator site 22 will always be the node in the network of processors that “owns” the source data structure. The other end of the NDC chain, the NDC client terminator site 24, is the NDC site that receives requests from the client workstation 42 to access data on the NDC server terminator site 22.

Data being written to the disk drive 32 at the NDC server terminator site 22 by the client workstation 42 flows in a “downstream” direction indicated by a downstream arrow 54. Data being loaded by the client workstation 42 from the disk drive 32 at the NDC server terminator site 22 is pumped “upstream” through the NDC chain in the direction indicated by an upstream arrow 56 until it reaches the NDC client terminator site 24. When data reaches the NDC client terminator site 24, the data and its accompanying metadata is reformatted into a reply message in accordance with the appropriate network protocol such as NFS, and sent back to the client workstation 42. NDC sites are frequently referred to as being either upstream or downstream of another NDC site. If consistent images of files are to be projected from NDCs 50 operating as server terminators to other NDCs 50 throughout the digital computer system 20, the downstream NDC site 22, 26A or 26B must be aware of the types of activities being performed at its upstream NDC sites 26A, 26B or 24 at all times.

As described in the patents identified above, for the networked digital computer system 20 depicted in FIG. 1, a single request by the client workstation 42 to read data stored on the disk drive 32 is serviced as follows.

1. The request flows across the LAN 44 to the NDC client terminator site 24 which serves as a gateway to the chain of NDC sites 24, 26B, 26A and 22. Within the NDC client terminator site 24, a NDC client intercept routine 102, illustrated in greater detail in FIG. 2, inspect the request. If the request is directed at any NDC sites 24, 26B, 26A or 22 for which the NDC client terminator site 24 is a gateway, then the request is intercepted by the NDC client intercept routine 102.

2. The NDC client intercept routine 102 converts the request from the protocol employed by the client workstation 42 into a DTP request, and then submits the request to an NDC core 106.

3. The NDC core 106 in the NDC client terminator site 24 receives the request and checks its NDC cache to determine if the requested data is already present there. If all data is present in the NDC cache of the NDC client terminator site 24, the NDC 50 copies pointers to the data into a reply message structure and immediately responds to the calling NDC client intercept routine 102.

4. If all the requested data isn't present in the NDC cache of the NDC client terminator site 24, then the NDC 50 of the NDC client terminator site 24 must retrieve the missing data. If the NDC client terminator site 24 is also the server terminator site, then the NDC 50 accesses the file system on the hard disk 34 upon which the data resides.

5. Since the NDC client site 24 is a client terminator site and not a server terminator site, the NDC 50 must request the data it needs from the next downstream NDC site, i.e., intermediate NDC site 26B in the example depicted in FIG. 1. Under this circumstance, a DTP client interface routine 108, illustrated in FIG. 2, are invoked to request from the intermediate NDC site 26B whatever additional data the NDC client terminator site 24 needs to respond to the current request.

6. A DTP server interface routine 104, illustrated in FIG. 2, at the downstream intermediate NDC site 26B receives the request from the NDC 50 of the NDC client terminator site 24 and processes it according to steps 3, 4, and 5 above. The preceding sequence repeats for each of the NDC sites 24, 26B, 26A and 22 in the NDC chain until the request reaches the server terminator, i.e., NDC server terminator site 22 in the example depicted in FIG. 1, or until the request reaches an intermediate NDC site that has cached all the data that is being requested.

7. When the NDC server terminator site 22 receives the request, its NDC 50 accesses the source data structure. If the source data structure resides on a hard disk, the appropriate file system code (UFS, DOS, etc.) is invoked to retrieve the data from the disk drive 32.

8. When the file system code on the NDC server terminator site 22 returns the data from the disk drive 32, a response chain begins whereby each downstream site successively responds upstream to its client, e.g. NDC server terminator site 22 responds to the request from intermediate NDC site 26A, intermediate NDC site 26A responds to the request from intermediate NDC site 26B, etc.

9. Eventually, the response percolates up through the sites 22, 26A, and 26B to the NDC client terminator site 24.

10. The NDC 50 on the NDC client terminator site 24 returns to the calling NDC client intercept routine 102, which then packages the returned data and metadata into an appropriate network protocol format, such as that for an NFS reply, and sends the data and metadata back to the client workstation 42.

The NDC 50

As depicted in FIG. 2, the NDC 50 includes five major components:
NDC client intercept routine 102;
DTP server interface routine 104;
NDC core 106;
DTP client interface routine 108; and
file system interface routine 112.

Routines included in the NDC core 106 implement the function of the NDC 50. The other routines 102, 104, 108 and 112 supply data to and/or receive data from the NDC core 106. FIG. 2 illustrates that the NDC client intercept routines 102 are needed only at NDCs 50 which may receive requests for data in a protocol other than DTP, e.g., a request in NFS protocol, SMB protocol, or another protocol. The NDC client intercept routines 102 are completely responsible for all conversions necessary to interface a projected dataset image to a request that has been submitted via any of the industry standard protocols supported at the NDC sites 24, 26B, 26A or 22.

The file system interface routines 112 are necessary in the NDC 50 only at NDC file server sites, such as the NDC server terminator site 22. The file system interface routines 112 route data between the disk drives 32A, 32B and 32C illustrated in FIG. 2 and a data conduit, provided by the NDCs 50 together with DTP messages 50, that provides a pathway for data which extends from the NDC server terminator site 22 to the NDC client terminator site 24.

If the NDC client intercept routines 102 of the NDC 50 receives a request to access data from a client, such as the client workstation 42, it prepares a DTP request indicated by an arrow 122 in FIG. 2. If the DTP server interface routines 104 of the NDC 50 receives a request from an upstream NDC 50, it prepares a DTP request indicated by the arrow 124 in FIG. 2. The DTP requests 122 and 124 are presented to the NDC core 106. Within the NDC core 106, the requests 122 or 124 cause a buffer search routine 126 to search a pool 128 of NDC buffers 129, as indicated by the arrow 130 in FIG. 2, to determine if all the data requested by either the routines 102 or 104 is present in the NDC buffers 129 of this NDC 50. If all the requested data is present in the NDC buffers 129, the buffer search routine 126 prepares a DTP response, indicated by the arrow 132 in FIG. 2, that responds to the requests 122 or 124, and the NDC core 106 appropriately returns the DTP response 132, containing both data and metadata, either to the NDC client intercept routines 102 or to the DTP server interface routines 104 depending upon which routine 102 or 104 submitted the requests 122 or 124. If the NDC client intercept routines 102 receives DTP response 132, before the NDC client intercept routines 102 returns the requested data and metadata to the client workstation 42 it reformats the response from DTP to the protocol in which the client workstation 42 requested access to the dataset, e.g. into NFS, SMB, Netware or any other protocol.

If all the requested data is not present in the NDC buffers 129, then the buffer search routine 126 prepares a DTP downstream request, indicated by the arrow 142 in FIG. 2, for only that data which is not present in the NDC buffers 129. A request director routine 144 then directs the DTP request 142 to the DTP client interface routines 108, if this NDC 50 is not located in the NDC server terminator site 22, or to the file system interface routines 112, if this NDC 50 is located in the NDC server terminator site 22. After the DTP client interface routines 108 obtains the requested data together with its metadata from a downstream NDC site 22, 26A, etc. or the file system interface routines 112 obtains the data from the file system of this NDC client terminator site 24, the data is stored into the NDC buffers 129 and the buffer search routine 126 returns the data and metadata either to the NDC client intercept routines 102 or to the DTP server interface routines 104 as described above.

In addition to storing projected images of stored datasets, the NDCs 50 detect a condition for a dataset, called a concurrent write sharing (“CWS”) condition, whenever two or more client sites concurrently access a dataset, and one or more of the client sites attempts to write the dataset. If a CWS condition occurs, one of the NDC sites, such as the NDC sites 22, 24, 26A and 26B in the digital computer system 20, declares itself to be a consistency control site (“CCS”) for the dataset, and imposes restrictions on the operation of other NDCs 50 upstream from the CCS. The operating restrictions that the CCS imposes upon upstream NDCs 50 guarantee throughout the network of digital computers that client sites, such as the client workstation 42, have the same level of file consistency as they would have if all the client sites operated on the same computer. That is, the operating conditions that the CCS imposes ensure that modifications made to a dataset by one client site are reflected in the subsequent images of that dataset projected to other client sites no matter how far the client site modifying the dataset is from the client site that subsequently requests to access the dataset.

While the United States patents identified above disclose how images of files may be cached at various computers within the system in the digital computer system 20 and how operation of NDCs 50 preserve consistent images of the files throughout the digital computer system 20, the disclosures of those patents omit any discussion of problems which arise when providing a reliable distributed file service that is layered upon an inherently unreliable network.

In a global network, portions of the network are likely to be isolated (due to a router failure, for example) or otherwise out of service. Layering a reliable, highly available distributed file service on top of an unreliable network requires new methods for ensuring the continuity of communications between NDCs 50.

### BRIEF SUMMARY

An object of the present disclosure is to reestablish a data conduit between an NDC client terminator site and an NDC server terminator site if an intermediate NDC site fails.

Another object of the present disclosure is to facilitate access by networked computers to images of files stored at other digital computers included in the same network.

Another object of the present disclosure is to present networked digital computers with a hierarchical view of files that may be accessed via the network.

Another object of the present disclosure is to automatically assemble geographically distributed, hierarchical virtual file servers which permit easy access to and management of files stored at disparate locations.

Yet another object of the present disclosure is to permit secure distribution of images of files among networked digital computers and to maintain consistency between files and their projected images.

Yet another object of the present disclosure is to authenticate both users and systems which access files via a digital computer network.

Yet another object of the present disclosure is to impose access mode controls on the use of files, e.g. read-only or read/write, accessed via a digital computer network.

Yet another object of the present disclosure is to monitor and control file access via a digital computer network with respect to connection management, content management, presentation management, and access logging.

Briefly, the present disclosure in one aspect is a more reliable method by which an upstream NDC site accesses via a downstream NDC site a file that is alternatively accessible through at least two downstream NDC sites. The upstream NDC site belongs to a first DDS domain and the downstream NDC sites belong to a second DDS domain which is a sub-domain of the first DDS domain. The method in this particular aspect of the disclosure includes each of the downstream NDC sites respectively having portal files. Each portal file stores at least two distinct network addresses for communicating respectively with different downstream NDC sites providing access to the file. A DDS domain manager at the upstream NDC site retrieves the portal file from at least one of the DDS domains at the downstream NDC sites providing access to the file. Then the upstream NDC site, using a first of the network addresses stored in the retrieved portal file, establishes a first data conduit for exchanging messages between the upstream NDC site and a first of the downstream NDC sites providing access to the file. If the upstream NDC site fails to receive a response to a message transmitted to the first of the downstream NDC sites, the upstream NDC site, using a second of the network addresses stored in the retrieved portal file, establishes a second data conduit, that differs from the first data conduit, for exchanging messages between the upstream NDC site and a second of the downstream NDC sites providing access to the file.

After the upstream NDC site establishes the second data conduit for exchanging messages with the second of the downstream NDC sites providing access to the file, the NDC sites, in another aspect of the present disclosure, ensure consistency between the file and the projected image of the file cached in the upstream NDC site. However, if a process operating at a client workstation accessing the file cached at the upstream NDC site requests consistency lower than absolute consistency, the NDC sites do not ensure absolute consistency between the file and the projected image of the file cached in the upstream NDC site.

These and other features, objects and advantages will be understood or apparent to those of ordinary skill in the art from the following detailed description of the preferred embodiment as illustrated in the various drawing figures.

### BRIEF DESCRIPTION OF THE DRAWINGS

FIG. 1 is a block diagram illustrating a prior art networked, multi-processor digital computer system that includes an NDC server terminator site, an NDC client terminator site, and a plurality of intermediate NDC sites, each NDC site in the networked computer system operating to permit the NDC client terminator site to access data stored at the NDC server terminator site;

FIG. 1A is a block diagram illustrating a conventional application for a load balancing router in interfacing between the Internet and a plurality of HTTP proxy caches;

FIG. 2 is a block diagram illustrating a structure of the prior art NDC included in each NDC site of FIG. 1 including the NDC's buffers;

FIG. 3 is a tree diagram illustrating several hierarchical domain trees;

FIG. 4 is a block diagram of an NDC that constitutes an atomic domain;

FIG. 5 is a tree diagram illustrating a domain tree exported by an atomic domain together with several directories and a symbolic link that are used in assembling the atomic domain's name space;

FIG. 6 is a tree diagram illustrating a domain tree exported by a domain manager of a non-atomic domain together with several directories and a symbolic link that are used in assembling the name space for the domain;

FIG. 7 is a block diagram illustrating a rotor mechanism included in NDC sites that is used in effecting a failover from one downstream DDS domain address to an alternative downstream DDS domain address;

FIG. 8 is a block diagram of an NDC, similar to the block diagram of FIG. 2, which illustrates addition of the rotor mechanism depicted in FIG. 7 to the NDC's request director routine;

FIG. 9 is a tree diagram, analogous to the tree diagram of FIGS. 3, 5 and 6, illustrating a multi-homed domain accessible through either one or the other of two intermediate NDC sites; and

FIG. 10 is a block diagram, analogous to the block diagram of FIG. 1, that illustrates various different routes between pairs of NDC sites which may be used in assembling a data conduit that extends between a client terminator site and a server terminator site.

### DETAILED DESCRIPTION

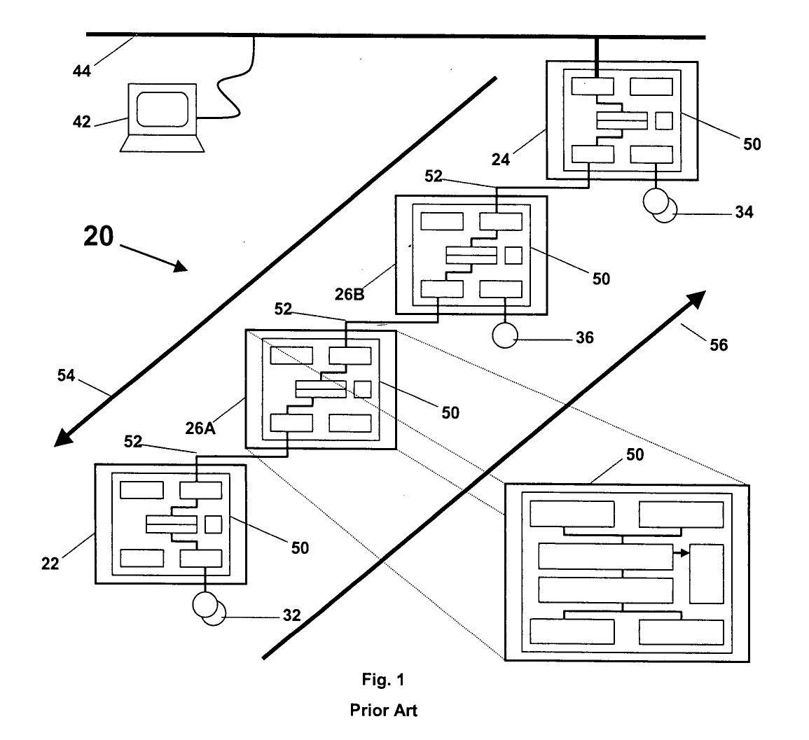

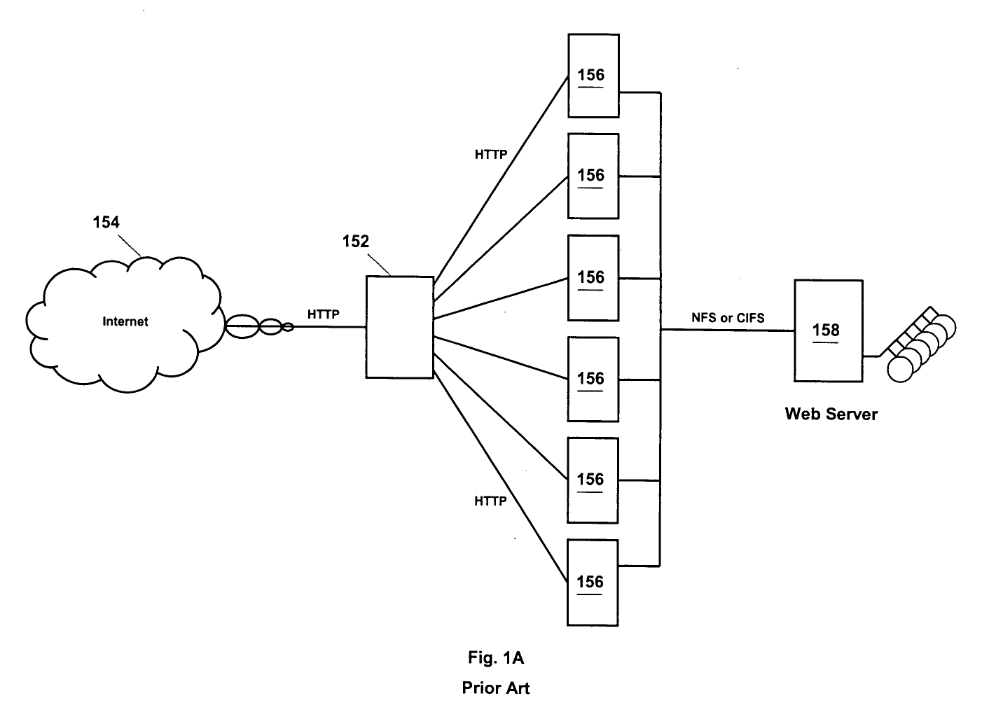

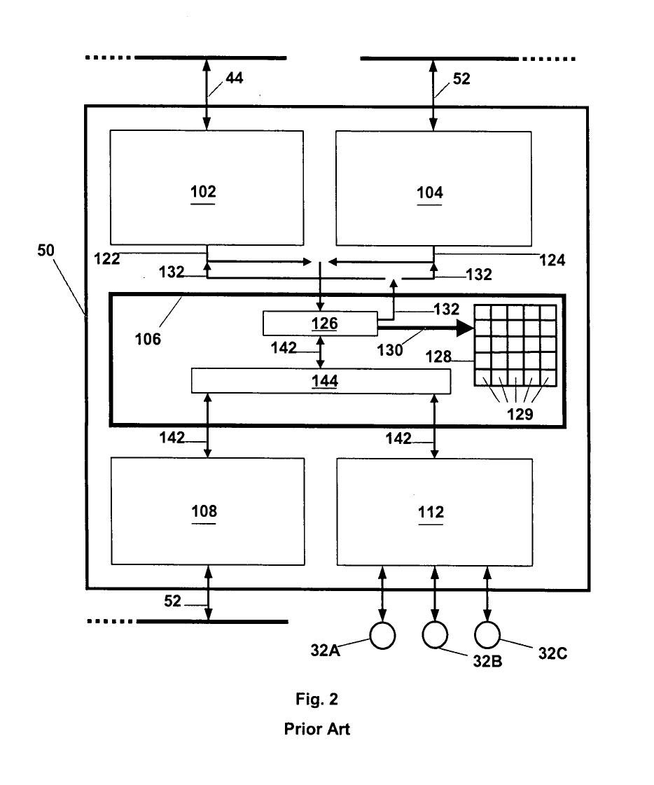

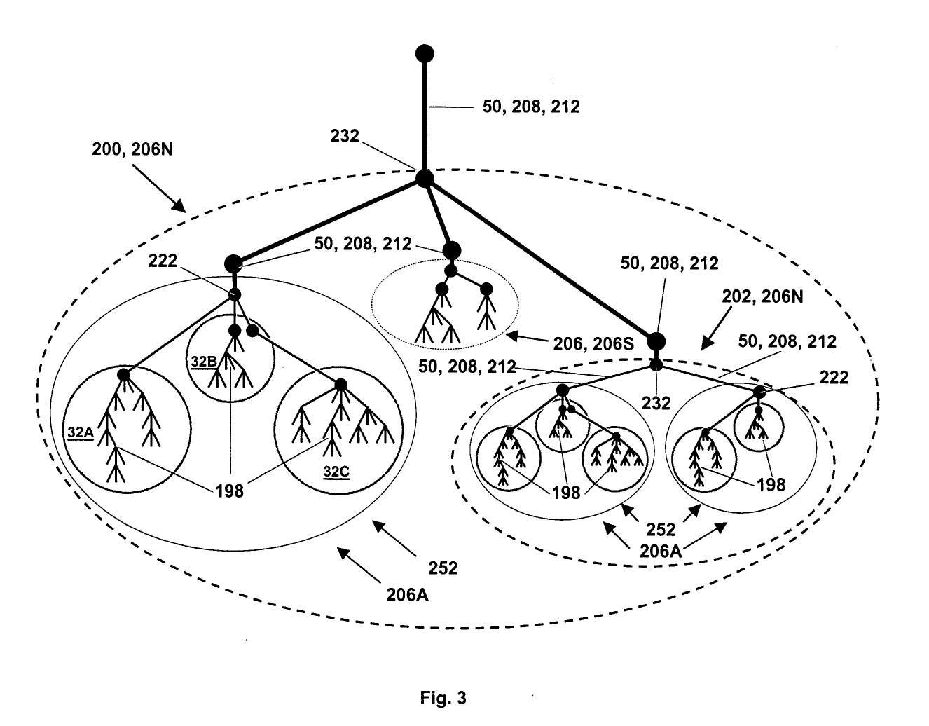

The structure and operation of the NDCs 50 depicted in FIGS. 1 and 2, and described in the patents identified above, can be advantageously exploited to establish a unified name space for accessing local file systems present respectively at each NDC site, such as the NDC sites 22, 24, 26A and 26B illustrated in FIG. 1. To other NDCs 50 included in the digital computer system 20, NDCs 50 which operate as NDC server terminator sites 22 can be viewed as exporting one or more file system trees 198 illustrated in FIG. 3. At each NDC 50, the exported file system trees 198 usually omit the true root of the local file system. By not exporting the true root of the local file system tree, each NDC 50 preserves one or more spaces on one or more disk drives 32 where may be stored vital system files that are essential to maintaining the integrity and security of exported files.

The unified name space that may be created includes one or more hierarchically organized domains that are assembled by grafting onto a single, hierarchical Distributed Data Service (“DDS”) domain tree, indicated in FIG. 3 by the general reference character 200, the hierarchical file system trees 198 that are exported from one or more NDCs 50. The overall DDS domain tree 200 may include one or more DDS sub-domain trees 202 that are enclosed within dashed ovals in FIG. 3. An arbitrarily chosen name, that is assigned to each DDS domain 206, respectively identifies roots 208 of the hierarchical DDS domain tree 200 and of each of the DDS sub-domain trees 202. In most respects, each DDS domain 206 and that domain's hierarchical DDS domain tree 200 or DDS sub-domain tree 202 are synonymous.

Each DDS domain 206 constitutes a named set of digital computing resources that are organized into the hierarchical DDS domain tree 200 or DDS sub-domain tree 202. Digital computing resources of the DDS domain 206 may be considered to be analogous to branches and leaves on a tree. Similar to a tree, each DDS domain 206 may have many branches and leaves, while always having but a single root 208. The hierarchical DDS domain tree 200 and DDS sub-domain trees 202 incorporate all local file system trees 198 that are exported from all NDC sites, such as the NDC sites 22, 24, 26A and 26B illustrated in FIG. 1, that are included in each respective DDS domain 206.

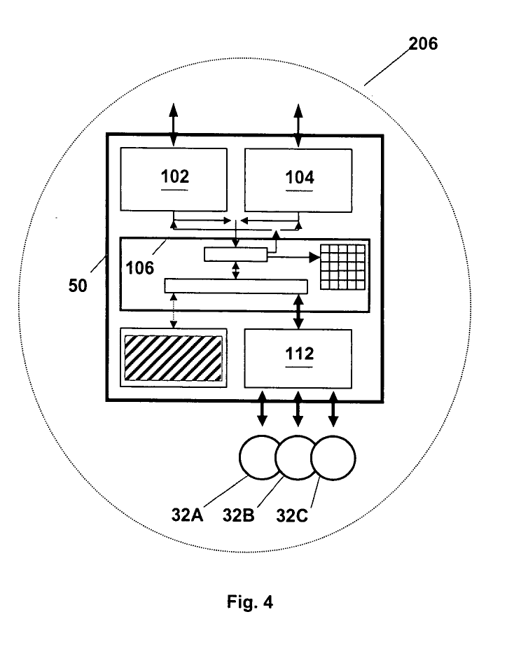

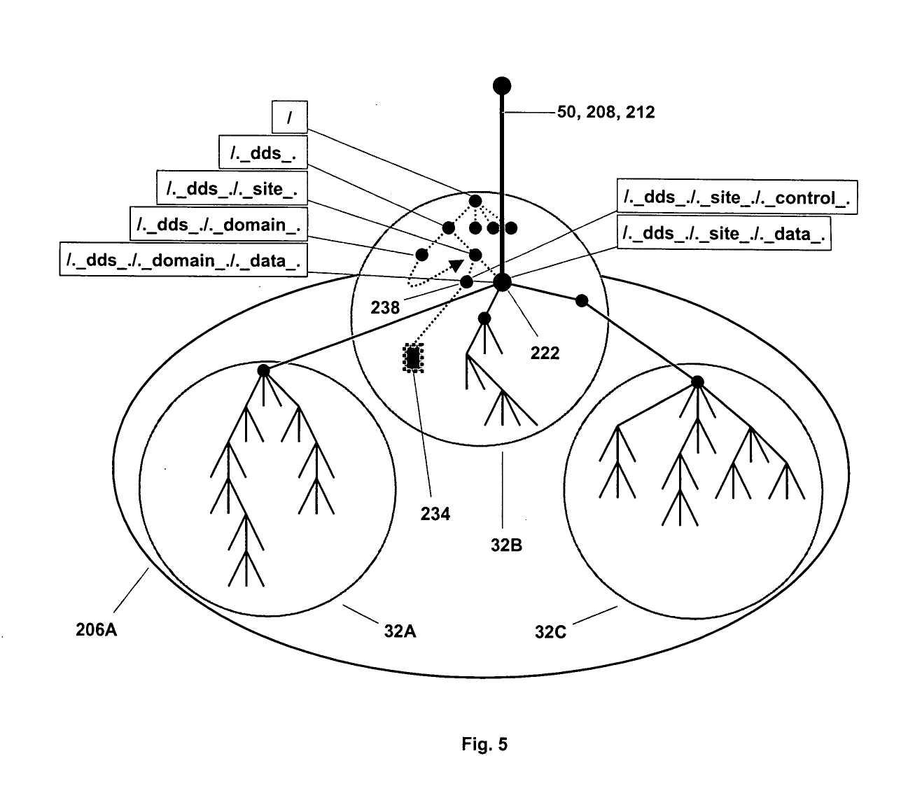

As used herein, an atomic DDS domain 206A, illustrated in greater detail in FIGS. 4 and 5, consists of one NDC 50 together with local physical or logical disk drives 32A, 32B and 32C, and one or more file systems that record files onto and retrieve files from the disk drives 32A, 32B and 32C. As explained in greater detail below, each atomic DDS domain 206A exports to an NDC 50 that has been designated as a domain manager 212 only a single root 208 upon which have been grafted the exported portion of local file system trees 198.

Any number of different and independent NDCs 50 may export the same DDS domain tree 200 in parallel with each other. In this way an arbitrary number of NDCs 50 may operate collaboratively in parallel to advantageously increase scalability and/or availability of a DDS domain tree 200.

During assembly of the DDS sub-domain trees 202 and ultimately the DDS domain tree 200, each DDS sub-domain 206S exports the root 208 of its portion of the DDS domain tree 200 using the name that identifies the DDS sub-domain 206S. In each DDS sub-domain 206S, the unexported portion of the local file system tree 198 includes a directory 222, best illustrated in FIG. 5 by an enlarged dot, that is preferably named
/._dds_./._site_./._data_.

During initialization, DDS creates the directory 222 which provides the root 208 for a DDS site tree 252 exported by the DDS sub-domain 206S. Sub-directories of the directory 222 (or possibly symbolic links) are created as required to provide contiguous name space linkage to the portion of the local file system trees 198 exported from each DDS domain 206. When the NDC 50 of DDS domains 206 receives a DDS_CONNECT DTP message 52 with a public file handle parameter of DDS_FH_DOMAIN_ROOT, the NDC 50 connects to a directory 232 in the unexported portion of the local file system tree 198 preferably named
/._dds_./._domain_./._data_.
The /._dds_./._domain_./._data_. directory 232 is the root 208 of the DDS domain tree 200 exported from the DDS domain 206. The directory 232 holds a symbolic link (“symlink”) to any local directory 222, and also directories 228 to which roots 208 of any DDS sub-domains 206S are grafted.

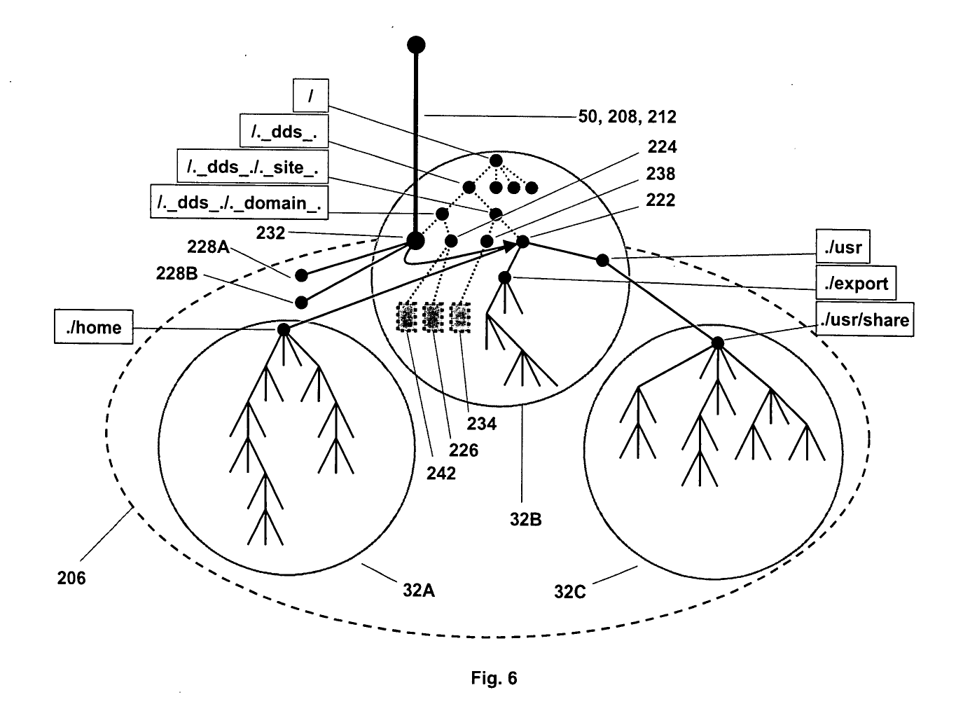

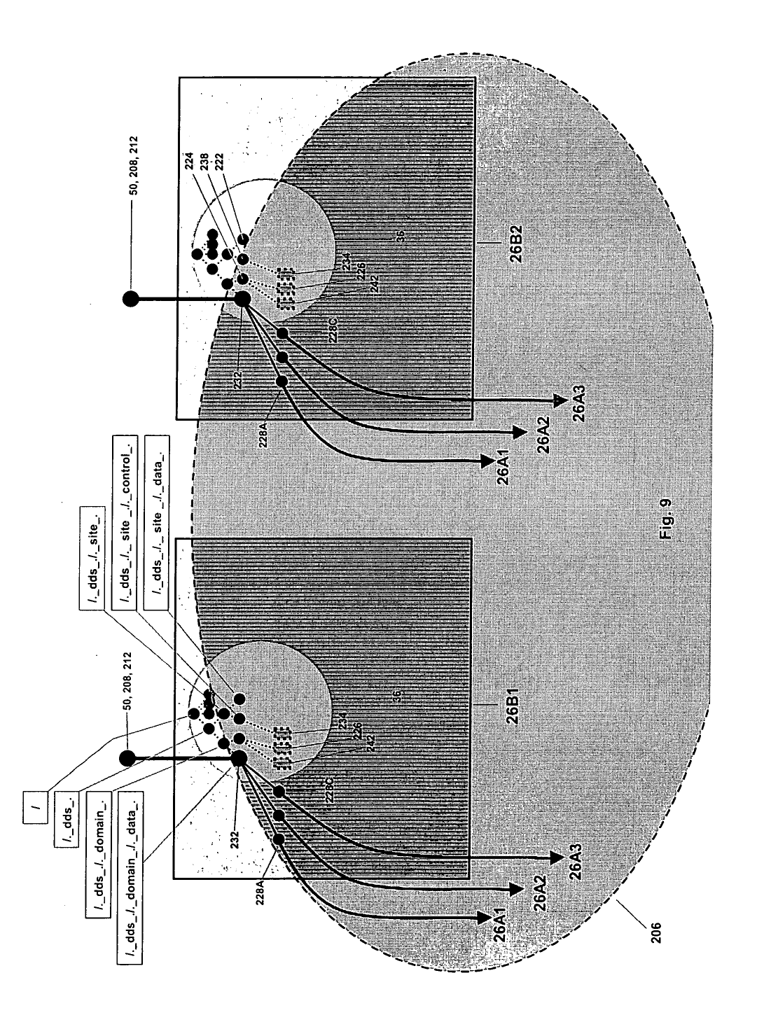

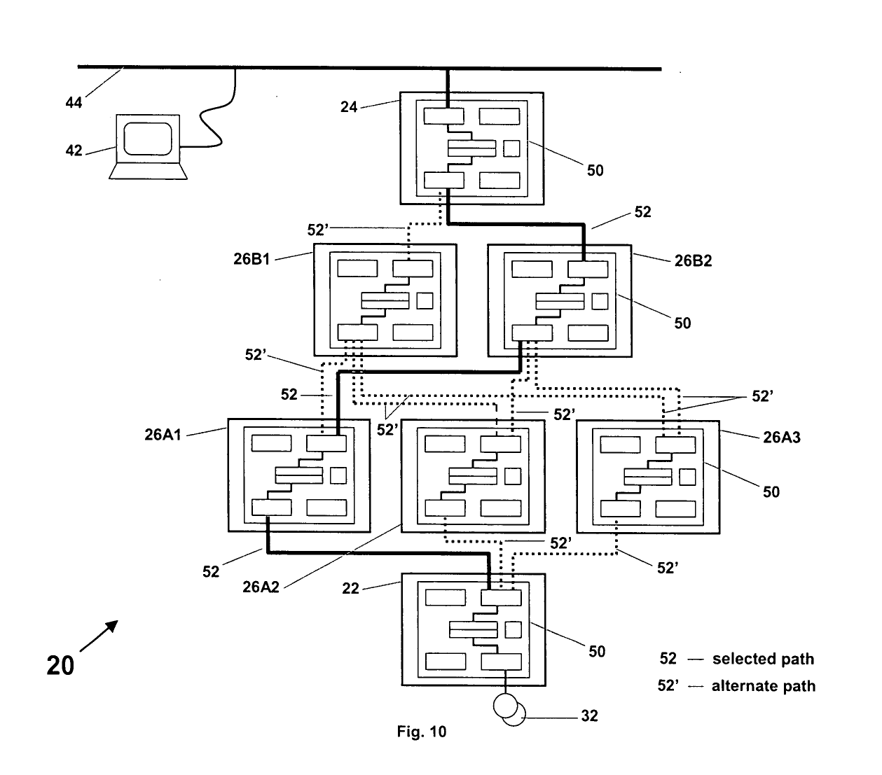

Referring now to FIG. 9, any intermediate NDC site, such as intermediate NDC site 26B, may, in accordance with the present disclosure, be replaced by two or more NDCs 50, better illustrated in FIG. 10, thereby establishing NDC sites 26B1 and 26B2 within a DDS domain 206. Each respective NDC 50 in the NDC sites 26B1 and 26B2 are assigned at least one distinct Internet Protocol (“IP”) address. A referral section of a domain portal file 242, depicted in FIG. 6 and described in greater detail below, specifies the IP addresses used in communicating with NDCs 50 in the NDC sites 26B1 and 26B2. DDS domains 206 having multiple NDCs 50 each of which has a distinct IP address are referred to as multi-homed domains. Such multi-homed domains provide the same service regardless of the network path by which the NDCs 50 receive and respond to DTP messages 52. An upstream NDC 50 addressing DTP messages 52 to a downstream NDC 50 using a particular IP address may switch to a different IP address at any time. Switching to a different IP address may temporarily increase file access latency as NDC buffers 129 “behind” NDC 50 along the new IP address' route (caches along an alternative route) cache data, but client workstations 42 receive the same data regardless of the IP address selected.

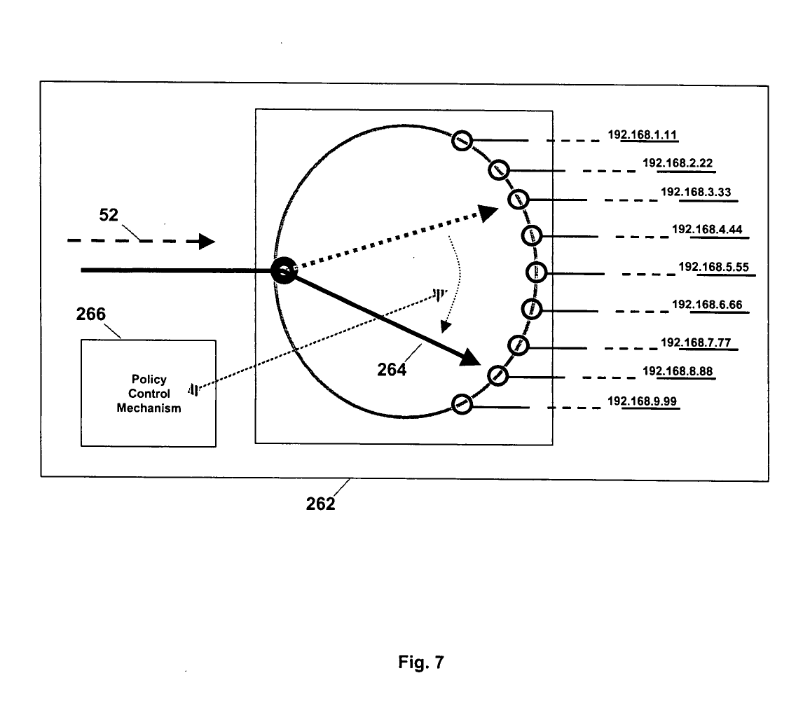

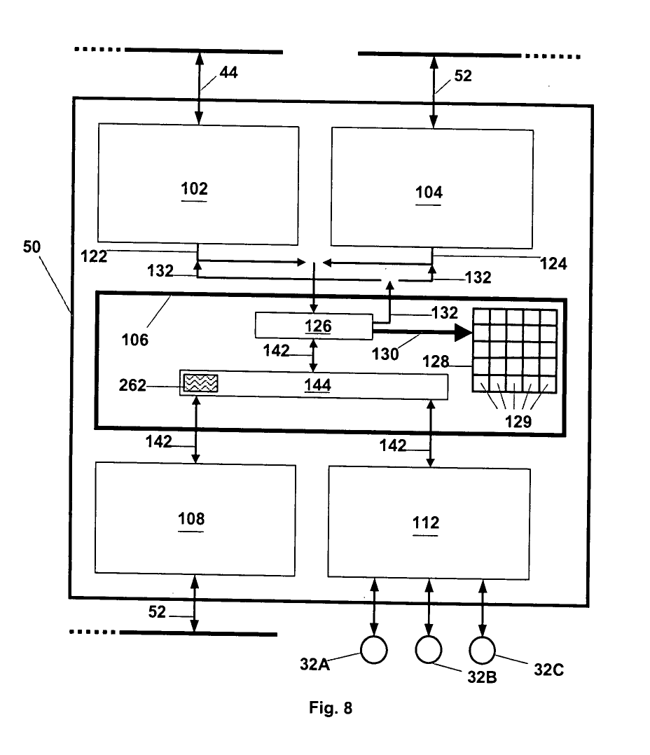

A rotor mechanism 262, depicted in the block diagram of FIG. 7 that as illustrated in FIG. 8 is included in the request director routine 144, selects a particular IP address for use in transmitting a request downstream to a multi-homed DDS sub-domain 206S. A switch 264 included in the rotor mechanism 262 is repositionable for selecting different IP address to be used in sending DTP messages 252 to the downstream NDC 50. The referral section of the domain portal file 242, in addition to providing the IP addresses for communicating with the DDS sub-domain 206, may also contain data specifying the characteristics of the communication link associated with each IP address, and may also contain data specifying control policies for the rotor mechanism 262. Such control policy data provides rules that a policy control mechanism 266 included in the rotor mechanism 262 may implement to govern switching. If the referral section of a domain portal file 242 fails to specify any rotor control policy, an upstream NDC 50 may use its own discretion in routing DTP messages 52 downstream toward the NDC server terminator site 22.

The information contained in the referral section of a domain portal file 242 is used to construct a routing table for communicating with downstream NDCs 50. Each entry in the table contains:
an IP address,
attributes of the communications link associated with the IP address, such as:
   bandwidth,
   whether link is public or private,
   whether link is encrypted on un-encrypted,
   geographic location of the NDC 50 site servicing requests sent to “IP address”,
   other . . . ,
data associated with current link usage:
   is the link presently operational?,
   message count,
   error count,
   average response time,
   other . . . .

Rotor control policies may be categorized as follows:
Round Robin
   The rotor mechanism 262 simply selects the next IP address in the routing table. The last IP address rolls over to become the routing table's first entry.
Load Balance
   The rotor mechanism 262 selects the IP address with the lowest average response time.
Failover
   The rotor mechanism 262 deselects the current IP address and, using the current rotor policy, selects an alternative, presumably operational, IP address for communicating with the NDC 50.
Random
   The rotor mechanism 262 randomly selects an IP address in the routing table.
Geographic
   The rotor mechanism 262 selects an IP address based on its geographic attributes, e.g. chooses the closest NDC 50.
Service Matching
   The rotor mechanism 262 selects the IP address entry that best matches the service requirements of client workstation 42. For example, a real time video data stream might be routed over a high bandwidth private link. Conversely, data being fetched to support NFS file accessed at the client terminator site 24 might be routed over a slower, less expensive link.
Maintenance
   The rotor mechanism 262 always selects a specified, presumably highly reliable, IP address in the routing table.

In selecting a particular routing for the data conduit between the NDC client terminator site 24 and the NDC server terminator site 22, an upstream domain manager 212 may refer to the downstream DDS sub-domain's 206S rotor control policies contained within the sub-domain's portal file 242. Dark black lines 52 in block diagram of FIG. 10 respectively connecting pairs of NDC sites 24-26B2, 26B2-26A1 and 26A1-22 illustrate a particular data conduit selected for exchanging DTP messages 52. This routing becomes part of a dataset's metadata. When an upstream NDC 50 receives a request to access a file most recently accessed months ago, if the dataset's metadata still persists (it may have been discarded by the site's least recently used (LRU) cache management policy), the routing originally selected for the data conduit may be used in re-establishing communication between pairs of NDCs 50. This feature, called routing persistence, increases the likelihood that requested data may be cached at downstream NDCs 50 as requests propagate toward the NDC server terminator site 22, and facilitates the more efficient allocation of downstream caching resources.

When an IP address change occurs, the DDS consistency mechanism is capable of maintaining absolute consistency for any cached image. However, since operating in a mode that provides lower consistency levels reduces demand on network communications, DDS may operate in modes that do not assure absolute data consistency. For example, data returned in response to a read request may be guaranteed to be current within the previous thirty (30) minutes. Generally, more rigorous DDS consistency modes are only selected when a dataset is being modified, particularly when it is being modified by several processes at a client workstation 42 or by several client workstations 42, i.e. either cooperating processes or collaborating users.

When operating in the highest DDS consistency mode, i.e. absolute consistency, all of the IP addresses of a multi-homed DDS domain 206 are functionally equivalent. A request to retrieve data from a dataset contained within a multi-homed DDS domain 206 may be received and processed at any of the domain's IP address, and the response will contain the same data regardless of which IP address receives and processes the request.

When a dataset is being accessed, an exchange of requests and responses flows between the NDC client site 24 and the NDC server terminator site 22. When this exchange of requests and responses flows through a DDS domain 206 into a multi-homed DDS sub-domain 206S, the request/response communications are directed to an IP address of the DDS sub-domain 206S selected by the domain manager 212 of the DDS domain 206 when establishing the data conduit. During the exchange of request/response messages after establishing the data conduit, a failure within the network infrastructure may occur so the currently selected IP address for the multi-homed DDS sub-domain 206S no longer operates, but an alternative path to the DDS sub-domain 206S continues functioning.

If after a specified interval an upstream NDC 50 fails to receive a response to a request, it may retransmit the request and wait once again for a response. After a few unsuccessful retransmissions, the domain manager 212 at the upstream site may failover (switch over) to another IP address for the DDS sub-domain 206S, and attempt to reestablish a connection to the dataset stored in the DDS sub-domain 206S. Dotted lines 52′ in FIG. 10 connecting pairs of NDCs 50 illustrate possible alternative paths which may be used for reestablishing the data conduit between the client terminator site 24 and the server terminator site 22. The process of attempting to reestablish a connection to the dataset may be applied repetitively until all of the sub-domain's IP alternative addresses have been tried, or until making a successful connection. When a connection is successfully reestablished, the request that has so far failed to elicit a response from the DDS sub-domain 206S is retransmitted again; this time along a path that probably now uses a different IP address for communicating with the sub-domain 206S.

Failovers occur automatically as required to compensate for the failures of network components and to compensate for network congestion. Processes at upstream NDCs 50 and client workstations 42 are, for the most part, unaware that a re-routing has occurred. However, a client process may occasionally receive a response to a request that contains a status flag indicating that a failover operation occurred during request processing. A process at upstream NDCs 50 and client workstations 42 receiving such a status flag may ignore it, or the process may proactively initiate an end-to-end re-routing of the data conduit to the dataset.

The ability to use alternate DDS sub-domain 206S IP addresses relies upon the DDS consistency mechanism, which ensures that all of a sub-domain's IP addresses provide an equivalent service. The term equivalent service means exactly the same data is contained in a response if absolute consistency has been previously selected as the DDS consistency mode. However, when a failover occurs along a data conduit operating at lower DDS consistency levels, a dataset image cached “behind” the new IP address may differ from the image cached “behind” the prior (failed) IP address. Since the process operating at the client workstation 42 has chosen a lower DDS consistency, the process can probably tolerate differences between cached images. However, receiving a status flag indicating that a failover occurred alerts the client process so it may take additional actions as required to appropriately resolve any image consistency issue.

When the dataset image cached “behind” the new IP address is older (more out of date) than the dataset image cached “behind” a failed IP address, the domain manager 212 implementing the failover operation ensures that the dataset image cached “behind” the new IP address is updated to reflect the dataset's current state. This procedure, when employed, guarantees that dataset images received by a client process sequence from one cached image to another with each successive image always being more current than the prior one. In this way a client process never receives a dataset image that “steps backward;” i.e. a response never contains data from a cached image that is older than the image received before the failover occurred.

When the domain manager 212 updates a cached image to reflect the dataset's current state following a failover operation and this new image is more current than the image that was being used prior to the failover operation, a status flag may be included in the response received by the requesting client process that indicates the response contains a dataset image that is more current than the image being used when the request first arrived at the domain 206.

Constructing a Domain Tree

The simplest possible hierarchical DDS domain 206N, illustrated by the DDS sub-domain tree 202 located along the right hand side of the FIG. 3, consists of at least two atomic DDS domains 206A together with a single domain manager 212. DDS creates each DDS domain tree 200 and DDS sub-domain tree 202 as follows.

1. During initialization, each NDC 50 which exports a local file system tree 198, and can therefore be a NDC server terminator site 22:
a. first creates the /._dds_./._site_./._data_. directory 222 in an unexported portion of the local file system tree 198; and
b. then creates sub-directories and symbolic links as required to provide contiguous name space linkage to the root of each exported portion of each file system tree 198 exported from the DDS domain 206;

2. each NDC 50, which has been designated as the domain manager 212 by having in an unexported portion of the local file system tree 198 a directory 224, illustrated by an enlarged dot, that is preferably named
/._dds_./._domain_./._control_.
that stores a file 226 preferably named ._domain_map_. that is illustrated in FIG. 6:
   a. creates in the unexported portion of the local file system tree 198 the directory 232, illustrated by an enlarged dot in FIG. 5, that is preferably named
      /._dds_./._domain_./._data_.
      that has sub-directories and symbolic links as required to provide contiguous name space linkage to the DDS sub-domain trees 202 for which it is the domain manager 212; and
   b. sequentially processes a list of member names of DDS sub-domains 206S read from the ._domain_map_. file 226 by:
      i. creating a subdirectory in the /._dds_./._domain_./._data_. directory 232 for each domain member name read from the ._domain_map_. file 226;
      ii. if the ._domain_map_. file 226 also specifies a logical name in addition to the physical name assigned to the member DDS domain 206, creating a symbolic link with the logical name in the /._dds_./._domain_./._data_. directory 232 that points to the sub-directory that was just created with the domain member's physical name;
      iii. interrogating Domain Name System (“DNS”), or an alternative name service such as Windows Internet Name Service (“WINS”) or Network Information Service (“NIS”), for each member name read from the ._domain_map_. file 226 and receiving from the DNS the IP address of the DDS sub-domain 206S;
      iv. sending a DDS_CONNECT DTP message 52 that has a public file handle parameter of DDS_FH_DOMAIN_ROOT to each IP address provided by DNS thereby connecting to the root 208 of each DDS sub-domain 206S; and
      v. issuing additional DTP messages 52 to each DDS sub-domain 206S to retrieve images:
         (1) of the root directory of the DDS sub-domain tree 202; and
         (2) of a portal file 242 of the DDS sub-domain 206S, if one exists: and

3. responsive to requests received from the domain manager 212, each DDS sub-domain 206S returns to the domain manager 212 images of:
a. the root directory to the DDS sub-domain 206S; and
b. the portal file 242 of the DDS sub-domain 206S, if one exists.

Every NDC 50 that has been designated as a domain manager 212 performs step 2. above. If a named DDS sub-domain 206S fails to respond to the DDS_CONNECT DTP message 52 having the public file handle parameter of DDS_FH_DOMAIN_ROOT sent by a domain manager 212, perhaps because the digital computer hosting the NDC 50 is not operating or, if operating, is not yet in a state in which it can respond to the DDS_CONNECT DTP message 52, the domain manager 212 periodically retransmits the DDS_CONNECT DTP message 52 until the named atomic DDS domain 206A or DDS sub-domain 206S responds set forth in step 3. above. If several retransmission attempts fail to elicit a response from the named DDS sub-domain 206S, the domain manager 212 continues processing the ._domain_map_. file 226 to construct the DDS domain tree 200. If a subsequent attempt by the domain manager 212 to communicate with a non-responding named DDS sub-domain 206S, perhaps attempting to fetch a file image that has been requested by the client workstation 42, fails, then the domain manager 212 sends an appropriate error message to the client workstation 42 indicating that the request cannot be satisfied at present. In this way, each domain manager 212 ultimately connects to all operating NDCs 50 of the DDS sub-domains 206S listed in the ._domain_map_. file 226 to thereby ultimately construct the entire DDS domain tree 200 illustrated in FIG. 3. Every file stored anywhere within the DDS domain tree 200 which is exportable is uniquely identified by a pathname whose leading components are the names assigned to the various nested DDS domains 206 within which the file resides.

A summary of fields that are included in the ._domain_map_. file 226 is set forth below.
DOMAIN domain name
MANAGERS names of the domain manager(s) 212 for this DDS domain 206
MEMBERS physical name(s) of DDS sub-domains 206S, each possibly followed by one or more logical names, for which this is the domain manager 212

While the DDS domain tree 200 is preferably assembled as described above, there exist alternative techniques by which domain managers 212 may establish connections to DDS sub-domains 206S. For example, instead of DDS sub-domains 206S exporting their respective roots 208 in response to the DDS_CONNECT DTP message 52, during initialization DDS sub-domains 206S could export their respective names and IP addresses by advertising them to all NDCs 50 connected to a LAN, such as the LAN 44. Upon receiving the broadcast names and IP addresses, every NDC 50 that has been designated a domain manager 212 would, using data stored in its ._domain_map_. file 226, determine whether it is the domain manager 212 for particular DDS sub-domains 206S, and if so, storing the name and IP address thereof appropriately into the /._dds_./._domain_./._data_. directory 232 for the domain manager 212.

As described thus far, individual DDS sub-domains 206S may belong to the domains of an unlimited number of domain managers 212, i.e concurrently be members of several DDS domains 206. Arranging DDS domain trees 200 or DDS sub-domain trees 202 such that several domain managers 212 manage identical groups of DDS sub-domains 206S likely ensures that files may be reliably accessed through one of the domain managers 212 if another of the domain managers 212 were to fail.

Accessing the Domain Tree

To access a file stored within a DDS domain 206, a client such as the client workstation 42 causes a DDS_CONNECT DTP message 52 that has a public file handle parameter of DDS_FH_DOMAIN_ROOT to be issued to a domain manager 212. The domain manager 212 receiving the DDS_CONNECT DTP message 52 with the public file handle parameter of DDS_FH_DOMAIN_ROOT responds by establishing a connection to the root 208 of the DDS domain tree 200. After connecting to the root 208 of the DDS domain tree 200, the client workstation 42 may navigate throughout the DDS domain tree 200 using standard file system operations.

Portal Files

As described thus far, operation of DDS is trusting and promiscuous. That is, any client workstation 42 can access any file exported by any DDS domain 206. Moreover, any NDC 50 can, in principle, declare itself to be a domain manager 212 for any DDS domain 206. Such operation of DDS permits any client workstation 42 or NDC 50 to retrieve file images from anywhere in the DDS domain tree 200, and to modify the file.

To facilitate managing files stored within the DDS domain tree 200, DDS provides a set of administrative controls of a type commonly available in current distributed file systems. These controls may include authentication both of users and of systems, access mode control, e.g. read-only or read/write, and encryption. However, as described in greater detail below, DDS can also be readily and easily adapted to provide additional types of administrative control and monitoring mechanisms, which include connection management, content management, presentation management, and access logging.

Administrative controls are preferably added to atomic DDS domains 206A by:

1. adding to each un-exported portion of the local file system tree 198 a directory 238, illustrated by an enlarged dot, that is preferably named
/._dds_./._site_./._control_.; and

2. storing in the /._dds_./._site_./._control_. directory 238 the site portal file 234.

A portal file, such as the site portal file 234, preferably includes the following sections.

Domain—the name of this DDS domain 206

Manager—the name(s) assigned to system(s) hosting NDC(s) 50 that provide the domain manager(s) 212 for this DDS domain 206

Referral—the IP address(es) of NDC(s) 50 that provide the domain manager(s) 212 for this DDS domain 206

Namespace—the name space to which this DDS domain 206 belongs

Registration—specifies where and/or how to register the root 208 of this DDS domain 206

Data Staging—Replicated File System, Scheduled Flushing, Arrested Write, . . .

Configuration—Mirror, RAID, Local Director, Global Director, . . .

Policy—the policies to be applied by the domain manager 212 for this DDS domain 206

Authentication—rules for granting access to files stored in the DDS domain tree 200 of this DDS domain 206

Encryption—provides security for files being transmitted upstream

Presentation—loadable modules required to view or manipulate the local DDS domain tree 200

Required Modules—the names of loadable modules that must be installed at upstream NDC client terminator sites 24 that attempt to access the DDS domain tree 200

Moreover, the file consistency provided by the NDCs 50 ensures that any change occurring in a domain portal file 242 will automatically invalidate all images of that portal file at all NDCs 50 in the digital computer system 20. Consequently, if a change is made in the portal file at an atomic DDS domain 206A, then the NDC 50 for any domain manager 212 that has previously received an image of the domain portal file 242 will automatically be notified that a new, up-to-date copy of the domain portal file 242 must be retrieved.

Although the present disclosure has been described in terms of the presently preferred embodiment, it is to be understood that such disclosure is purely illustrative and is not to be interpreted as limiting. As used herein, domain manager characterizes a single function that may be hosted at multiple NDC sites 50. Accordingly, domain manager may be referred to either in the singular or plural. Depending upon a particular location in the hierarchical DDS domain tree, a particular DDS domain may be either a domain or a sub-domain. Consequently, without departing from the spirit and scope of the disclosure, various alterations, modifications, and/or alternative applications will, no doubt, be suggested to those skilled in the art after having read the preceding disclosure. Accordingly, it is intended that the following claims be interpreted as encompassing all alterations, modifications, or alternative applications as fall within the true spirit and scope of the disclosure including equivalents thereof. In effecting the preceding intent, the following claims shall:

1. not invoke paragraph 6 of 35 U.S.C. § 112 as it exists on the date of filing hereof unless the phrase “means for” appears expressly in the claim's text;

2. omit all elements, steps, or functions not expressly appearing therein unless the element, step or function is expressly described as “essential” or “critical;”

3. not be limited by any other aspect of the present disclosure which does not appear explicitly in the claim's text unless the element, step or function is expressly described as “essential” or “critical;” and

4. when including the transition word “comprises” or “comprising” or any variation thereof, encompass a non-exclusive inclusion, such that a claim which encompasses a process, method, article, or apparatus that comprises a list of steps or elements includes not only those steps or elements but may include other steps or elements not expressly or inherently included in the claim's text.

What is claimed is:

1. A more reliable method by which an upstream NDC site accesses via a downstream NDC site a file that is alternatively accessible through at least two downstream NDC sites; the upstream NDC site being included in a first DDS domain and the downstream NDC sites being included in a second DDS domain which is a sub-domain of the first DDS domain, the method comprising the steps of:
a. each of the downstream NDC sites respectively having portal files, each portal file storing at least two distinct network addresses for communicating respectively with the downstream NDC sites providing access to the file; and
b. a DDS domain manager at the upstream NDC site retrieving the portal file from at least one of the DDS domains at the downstream NDC sites providing access to the file;
c. the upstream NDC site, using a first of the network addresses stored in the retrieved portal file, establishing a first data conduit for exchanging messages between the upstream NDC site and a first of the downstream NDC sites providing access to the file; and
d. when the upstream NDC site fails to receive a response to a message transmitted to the first of the downstream NDC sites, the upstream NDC site, using a second of the network addresses stored in the retrieved portal file, establishing a second data conduit, that differs from the first data conduit, for exchanging messages between the upstream NDC site and a second of the downstream NDC sites providing access to the file.

2. The method of claim 1 wherein the upstream NDC site establishes the second data conduit after failing to receive a timely response to the message transmitted to the downstream NDC site.

3. The method of claim 1 wherein the upstream NDC site failing to receive a response to the message transmitted to the downstream NDC site retransmits the message and again waits for a response from the downstream NDC site providing access to the file.

4. The method of claim 1 wherein the portal file retrieved by the upstream DDS domain manager from the downstream DDS domain also includes control policy data which provides rules used by the upstream DDS domain manager in selecting the network address for communicating between the upstream NDC site and the downstream NDC site.

5. The method of claim 1 wherein the portal file retrieved by the upstream DDS domain manager from the downstream DDS domain stores network addresses for more than two NDC sites via which the file is alternatively accessible, and when the upstream NDC site using the second of the network addresses stored in the retrieved portal file fails in establishing a data conduit for communicating with the downstream NDC site, the upstream NDC site, using another of the network addresses stored in the retrieved portal file that differs from the first and from the second network addresses, again attempts to establish a second data conduit for communicating between the upstream NDC site and another of the downstream NDC sites providing access to the file.

6. The method of claim 1 wherein the portal file retrieved by the upstream DDS domain manager from the downstream DDS domain stores network addresses for more than two NDC sites via which the file is alternatively accessible, and after the upstream NDC site establishes the second data conduit the upstream NDC site fails to receive a response to a message transmitted to the second of the downstream NDC sites, the upstream NDC site, using another of the network addresses stored in the retrieved portal file that differs from the first and from the second network addresses, again attempts to establish another data conduit for communicating between the upstream NDC site and another of the downstream NDC sites providing access to the file.

7. A more reliable method by which an upstream NDC site accesses via a downstream NDC site a file that is alternatively accessible through at least two downstream NDC sites; the upstream NDC site being included in a first DDS domain and the downstream NDC sites being included in a second DDS domain which is a sub-domain of the first DDS domain, the method comprising the steps of:
a. a DDS domain manager at the upstream NDC site, possessing at least two distinct network addresses for communicating respectively with the downstream NDC sites providing access to the file, using a first of the network addresses for establishing a first data conduit for exchanging messages between the upstream NDC site and a first of the downstream NDC sites providing access to the file; and
b. when the upstream NDC site fails to receive a response to a message transmitted to the first of the downstream NDC sites, the upstream NDC site, using a second of the network addresses, establishing a second data conduit, that differs from the first data conduit, for exchanging messages between the upstream NDC site and a second of the downstream NDC sites providing access to the file; and
c. after the upstream NDC site establishes the second data conduit for exchanging messages with the second of the downstream NDC sites providing access to the file, the NDC sites ensuring consistency between the file and a projected image of the file cached in the upstream NDC site.

8. The method of claim 7 wherein the upstream NDC site establishes the second data conduit after failing to receive a timely response to the message transmitted to the downstream NDC site.

9. The method of claim 7 wherein the upstream NDC site failing to receive a response to the message transmitted to the downstream NDC site retransmits the message and again waits for a response from the downstream NDC site providing access to the file.

10. The method of claim 7 wherein the DDS domain manager at the upstream NDC site also possesses control policy data which provides rules used by the upstream DDS domain manager in selecting the network address for communicating between the upstream NDC site and the downstream NDC site.

11. The method of claim 7 wherein the portal file retrieved by the upstream DDS domain manager from the downstream DDS domain stores network addresses for more than two NDC sites via which the file is alternatively accessible, and when the upstream NDC site using the second of the network addresses stored in the retrieved portal file fails in establishing a data conduit for communicating with the downstream NDC site, the upstream NDC site, using another of the network addresses stored in the retrieved portal file that differs from the first and from the second network addresses, again attempts to establish a second data conduit for communicating between the upstream NDC site and another of the downstream NDC sites providing access to the file.

12. The method of claim 7 wherein the portal file retrieved by the upstream DDS domain manager from the downstream DDS domain stores network addresses for more than two NDC sites via which the file is alternatively accessible, and after the upstream NDC site establishes the second data conduit the upstream NDC site fails to receive a response to a message transmitted to the second of the downstream NDC sites, the upstream NDC site, using another of the network addresses stored in the retrieved portal file that differs from the first and from the second network addresses, again attempts to establish another data conduit for communicating between the upstream NDC site and another of the downstream NDC sites providing access to the file.

13. The method of claim 7 wherein the NDC sites, responsive to a process operating at a client workstation accessing the file cached at the upstream NDC site requesting consistency lower than absolute consistency, do not ensure absolute consistency between the file and the projected image of the file cached in the upstream NDC site.
